(19) United States
(12) Patent Application Publication
(10) Pub. No.: US 2017/0264830 A1
(43) Pub. Date: Sep. 14, 2017

(54) SMARTPHONE WITH A VR CONTENT CAPTURING ASSEMBLY

(71) Applicant: EFFIRE UNIVERSAL LIMITED, Hong Kong (CN)

(72) Inventor: Igor Udodov, Moscow (RU)

(73) Assignee: EFFIRE UNIVERSAL LIMITED, Hong Kong (CN)

(21) Appl. No.: 15/261,714

(22) Filed: Sep. 9, 2016

(30) Foreign Application Priority Data
Mar. 11, 2016 (CN) 201620186549.9

(51) Int. Cl. H04N 5/247; H04M 1/02; G06T 19/00; H04N 5/225; H04N 5/232

(52) U.S. Cl. CPC H04N 5/247; H04N 5/2257; H04N 5/23238; G06T 19/006; H04M 1/0264

(57) ABSTRACT

The present utility model relates to a smartphone with a VR content capturing assembly, wherein said VR content capturing assembly comprises: at least two cameras, which cooperatively cover a total angle of view of at least 360° in at least one of the length dimension, height dimension and width dimension of the smartphone. The smartphone can be any other portable device. (FIG. 1)

### TECHNICAL FIELD

This utility model generally relates to a portable VR content production device, and more particular, to a smartphone with a VR content capturing assembly.

### BACKGROUND

Virtual reality or virtual realities (VR), can be referred to as immersive multimedia or computer-simulated reality, replicates an environment that simulates a physical presence in places in the real world or an imagined world, allowing the user to interact in that world. VR artificially create sensory experiences, which can include sight, touch, hearing, and smell.

One typical type of VR is Immersive VR, in which VR content is collected and processed, and can be played back on a specific device to rebuilt a scene the wearer can be immersed in. VR content is a multimedia content (photo or video content), that covers complete field of view (FOV) of the scene around registering device, such as a phone, especially a smartphone, 360 degrees in all planes, which may be accompanied by audio content. VR content can be played back on different VR headsets available on the market, such as Oculus Rift, Google Cardboard, Sony HMZ-T1, Silico MicroDisplay ST1080 and others, to achieve immersive effect of presence at the scene. VR content can also be played back on non-VR devices using special software for playback.

There are various existing devices which can be used to collect the VR content. However, these devices have only one function (VR content capturing) and have to be carried separately, which is not convenient for everyday use. In addition, they are expensive.

Thus, it is desirable to provide a device capable of capturing/recording high quality VR content in an easy and inexpensive manner.

### SUMMARY OF THE UTILITY MODEL

This utility model aims to solve the problem by providing a smartphone having a VR content capturing assembly.

Specifically, a smartphone is provided having a VR content capturing assembly, wherein said VR content capturing assembly comprises: at least two cameras, which cooperatively cover a total angle of view of at least 360° in at least one of the length dimension, height dimension and width dimension of the smartphone.

In a preferred variant, in the dimension wherein the coverage of a total angle of view of at least 360° is obtained, the angles of view of any two adjacent cameras overlap with each other.

In a preferred variant, said at least two cameras are six cameras each of which is located on one face of the smartphone.

In a preferred variant, said smartphone comprises 3 pairs of side faces, the faces of each pair parallel to and opposite to each other, the two cameras on respective ones of each pair are located at the same positions of respective faces.

In a preferred variant, the cameras on the front, back, left and right sides of the smart phone are all located at the upper parts of respective smartphone faces.

In a preferred variant, said at least two cameras are 2, 3, 4 or 5 cameras.

In a preferred variant, at least one of the smartphone faces is provided with more than one camera, or is not provided with any camera.

In a preferred variant, said VR content capturing assembly further comprises microphones the quantity of which is identical with that of the cameras and each of which is paired with one corresponding camera, for capturing audio signals associated with the angle of view of a respective paired camera.

In a preferred variant, said VR content capturing assembly further comprises microphones the quantity of which is identical with that of the cameras and each of which is paired with one corresponding camera, for capturing audio signals associated with the angle of view of a respective paired camera.

In a preferred variant, said VR content capturing assembly further comprises a gyroscope or magnetic compass for compensating smartphone orientation changes during capture of VR content.

In a preferred variant, said VR content capturing assembly further comprises a data processing unit, which is integrated with or separate from the smartphone.

It is also provided a portable device with a VR content capturing assembly, wherein said VR content capturing assembly comprises: at least two cameras, which cooperatively cover a total angle of view of at least 360° in at least one of the length dimension, height dimension and width dimension of the portable device.

Smartphone is a commonly used electronic device and is easy to carry and operate; with the VR content capturing assembly installed on the smartphone, separate device or specific holders, which might be expensive and inconvenient to carry, is eliminated, and thus the VR content can be captured in an easy and inexpensive manner. Also, with the at least two cameras, which cooperatively cover a total angle of view of at least 360° in at least one of the length dimension, height dimension and width dimension of the smartphone, a high quality VR content can be achieved.

### BRIEF DESCRIPTION OF THE DRAWINGS

The utility model, its nature as well as its advantages, shall be described in more detail below with the aid of the accompanying drawings. Referring to the drawings.

FIG. 1 schematically shows six side views of an embodiment of the smartphone having a VR content capturing assembly, with each side provided with one camera and one corresponding microphone paired with said camera;

FIGS. 2A-2C illustrates coverage areas (CA) of the cameras/microphones and their overlapping around the smartphone, in the height, width and length dimensions, respectively.

FIG. 3 illustrates a functional block diagram of VR content production technical solution according to one embodiment of the present utility model.

FIGS. 4A-4C illustrates coverage areas of the cameras/microphones and their overlapping around the smartphone, with only 4 cameras present.

### DETAILED DESCRIPTION OF THE EMBODIMENTS

The following embodiments are described regarding a “smartphone”. However, all the configurations are applicable to other personal devices, such as tablet PCs, notebooks or other kinds of cell phones.

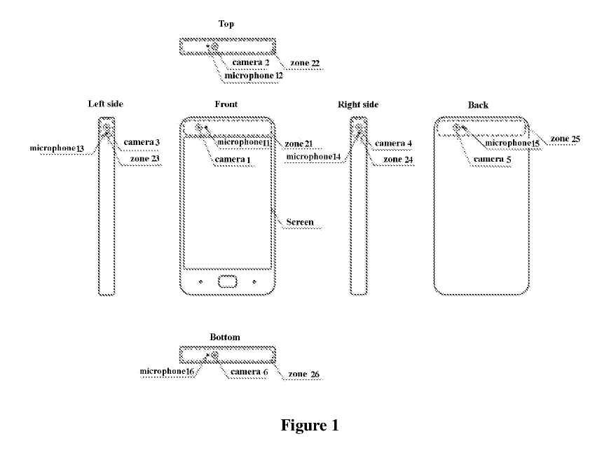

FIG. 1 illustrates one embodiment of a smartphone with a VR content capturing assembly, wherein for each of 6 sides of the smartphone, there is provided one camera. Surfaces on which cameras are located should meet the following conditions, which are actually quite common for a smartphone:
1. Front and Back sides are parallel to each other and perpendicular to Left, Right, Top and Bottom sides
2. Left and Right sides are parallel to each other and perpendicular to Front, Back, Top and Bottom sides
3. Top and Bottom sides are parallel to each other and perpendicular to Front, Back, Left and Right sides.

The positions of various cameras on different sides of the smartphone can be seen from FIG. 1. For the ease of explanation, the cameras on the front, top, left, right, back and bottom sides are numbered as camera 1, camera 2, camera 3, camera 4, camera 5 and camera 6, respectively. As seen from FIG. 1, the position of the camera 1 on the front side of the smartphone generally corresponds to the position of the camera 5 on the back side. Likewise, the positions of cameras 3 and 4 may generally correspond to each other, and the positions of cameras 2 and 6 may generally correspond to each other. Such an arrangement forms a symmetrical distribution of the cameras, and the produced visual data (video/image) of each camera may be more compatible with each other, which facilitates the subsequent stitches of the visual data (video/image) produced by said cameras.

The cameras 1, 2, 3, 4, 5, and 6 do not protrude from the surface levels of the faces on which they are disposed. In this way, the risk of rubbing and damaging camera lenses is minimised, and the smartphone would be convenient for use and have an aesthetically pleasant appearance. The lenses of the cameras 1, 2, 3, 4, 5, and 6 may be covered by flat protective glass lens to ensure the safety of said lenses not protruding from the surface level, and to minimize lens flare and other negative optical effects, comparing to 180 degree FOV cameras.

Microphones and cameras may be placed in pairs on each of 6 sides of the smartphone, as also illustrated in FIG. 1. In this arrangement, each of the cameras 1, 2, 3, 4, 5, and 6 is paired with a corresponding microphones 11, 12, 13, 14, 15 and 16, which may be arranged adjacent respective paired cameras. When microphones and cameras are placed in pairs on each of 6 sides of the smartphone, each microphone is responsible for capturing the audio data corresponding to its paired camera. Thus, the arrangement of the microphones corresponds to that of associated cameras, as illustrated in FIG. 1. Each camera and microphone pair records the part of the scene (scene segment), according to its' coverage areas. Upon putting together all the parts, the complete scene is recorded (360 degrees in all planes of space), making the complete VR content.

Each scene segment recorded by one camera and microphone pair should include parts of scene segments recorded by other pairs of cameras and microphones (coverage areas of adjacent cameras should overlap) in order to achieve seamless record of complete scene.

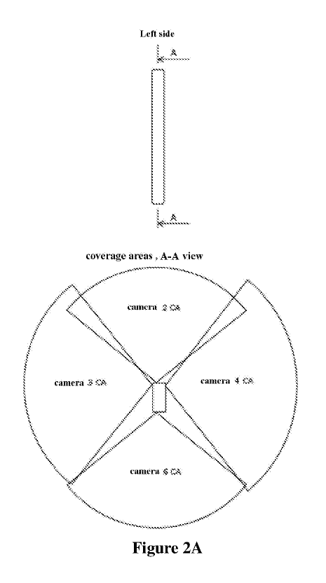

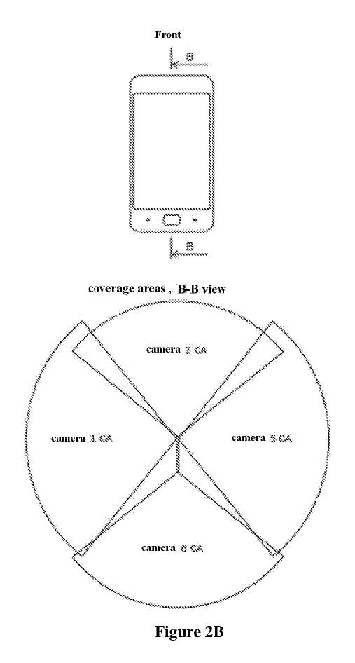

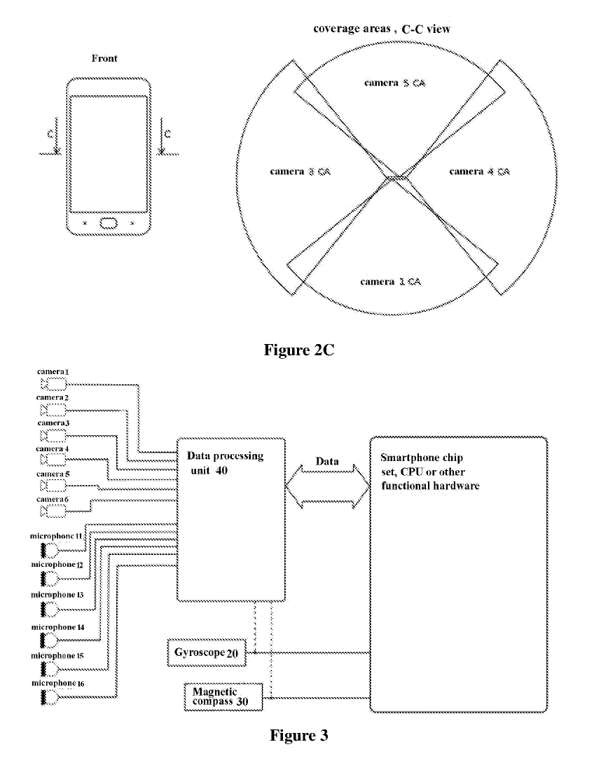

FIGS. 2A-2C illustrates coverage areas (CA) of the cameras/microphones and their overlapping around the smartphone for the content production. With the cameras disposed on 6 sides of the smartphone as discussed above, for each of the length, width and height dimensions of the device, 4 cameras are provided for capturing video/static images. Each camera's horizontal and vertical angle of view (AOV) is more than 90 degrees to ensure that a total AOV of 360° can be obtained in each dimension, and proper overlaps exist between AOVs of adjacent cameras. The center of each camera's coverage area is preferably perpendicular to the surface on which the camera is placed.

As illustrated in FIG. 2A, when viewed from the front or back side of the smartphone, the total coverage area around a center axis passing through the center point of the front or back side and perpendicular thereto is composited by the coverage areas of the top camera 2, left camera 3, right camera 4 and bottom camera 6, wherein the coverage areas for adjacent cameras (i.e. camera 2 and camera 3, camera 3 and camera 6, camera 6 and camera 4, camera 4 and camera 2)overlap with each other. For ease of explanation, we designate this total coverage area as a height dimension coverage area (around an axis along the height dimension of the device).

Likewise, as illustrated in FIG. 2B, when viewed from the left or right side of the smartphone, the total coverage area around a center axis passing through the center point of the left or right side and perpendicular thereto is composited by the coverage areas of the top camera 2, front camera 1, back camera 5 and bottom camera 6, wherein the coverage areas for adjacent cameras (i.e. camera 2 and camera 1, camera 1 and camera 6, camera 6 and camera 5, camera 5 and camera 2)overlap with each other. We could designate this total coverage area as a width dimension coverage area (around an axis along the width dimension of the device).

As illustrated in FIG. 2C, when viewed from the top or bottom side of the smartphone, the total coverage area around a center axis passing through the center point of the top or bottom side and perpendicular thereto is composited by the coverage areas of the front camera 1, left camera 3, back camera 5 and right camera 4, wherein the coverage areas for adjacent cameras (i.e. camera 1 and camera 3, camera 3 and camera 5, camera 5 and camera 4, camera 4 and camera 1)overlap with each other. We could designate this total coverage area as a length dimension coverage area (around an axis along the length dimension of the device).

For the convenience of grasping, cameras/microphones on the Front, Back, Top, Left and Right sides are placed in the upper part of the smartphone, and camera/microphone on the Bottom surface of the device is/are located on the Bottom side. As illustrated in FIG. 1, the cameras 1, 2, 3, 4, 5 and microphones 11,12,13,14,15 are placed in zones 21, 22, 23, 24 and 25 of the smartphone, respectively, while camera 6 and microphone 16 are located in the bottom zone 26. This camera and microphone placement allows to record VR content, covering complete scene at 360 degrees on any plane. In addition to that, while holding smartphone in hand, the hand is not likely to appear on the scene as it is not covered by any camera's coverage areas, and it does not cover any microphone, so it almost does not affect VR content recording.

Of course, the positions, quantity, and distributions of the cameras and/or microphones may vary.

Cameras and microphones positions may change within the surfaces on which they are placed. As an example, where 6 cameras are employed as discussed above, each camera can be located in the geometrical center of one smartphone side face, which will allow an optimal capture and stitch of videos/images. In this case, a simple stick may be used to hold the smartphone during the VR videos/images capture, which stick may be as simple as a commonly used selfie stick. Other positions are possible as well, as long as the cameras can cooperatively cover an angle of view of 360° in at least one of the height, width, and length dimensions. Different locations of the cameras or microphones may affect the immersive effect of the VR content.

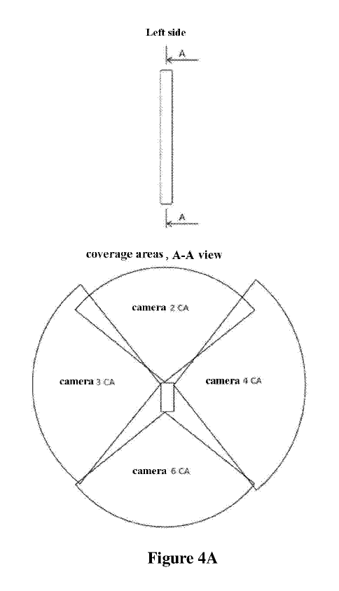

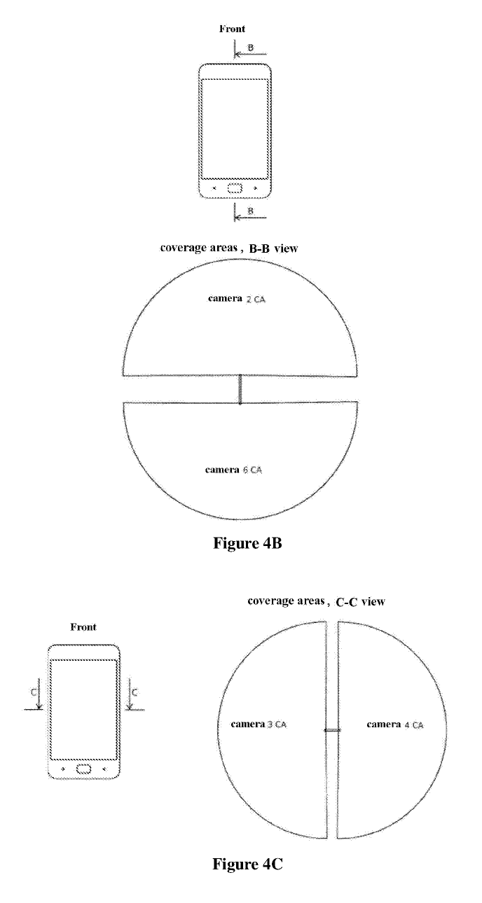

In another aspect, thought the embodiment illustrated in FIGS. 1 and 2A-2C employs 6 cameras, at least 2 cameras may be sufficient. That is, one or more of the cameras can be omitted (e.g. top camera and/or bottom camera). This may result in missing parts of the scene (which can be replaced by some image insertion), which still is enough to produce VR content with less strong immersive effect. FIGS. 4A-4C illustrates an embodiment wherein the front camera 1 and back camera 5 are omitted, and only 4 cameras, the top camera 2, bottom camera 6, left camera 3 and right camera 4 are included. In this situation, as shown in FIG. 4A, all the top camera 2, bottom camera 6, left camera 3 and right camera 4 cooperate to cover an AOV of 360° around a height direction axis. In FIG. 4B, the top camera 2 and bottom camera 6 cooperatively cover an AOV of 360° around a width direction axis. In FIG. 4C, the left camera 3 and right camera 4 cooperatively cover an AOV of 360° around a length direction axis. The quantity of the cameras is not limited to even number, an odd number of cameras, such as 3 and 5 cameras, are also possible, as long as they can cooperatively cover an angle of view of 360° in at least one of the height, width, and length dimensions. Furthermore, even only 2 cameras, such as one on front side and the other on back side of the smartphone, may also produce VR content, but in this case they require special lens with 180 degrees angle of view. Camera minimum viewing angle requirement depends on quantity of cameras and should be enough to make the cameras cooperatively cover an AOV of 360°, and preferably to make cameras' covering range overlap.

Further, for each side face of the smartphone, more than one cameras may be disposed thereon. This may help to add stereoscopic effect for VR content.

Microphone quantity can be 1 or more and may not be paired with cameras. This will not affect VR content production, but will affect immersive effect.

In a variant, cameras may protrude. This does not affect VR content recording.

In a further embodiment, in addition to the cameras and microphones, the VR content capturing assembly may also comprises a Data Processing Unit (DPU) 40. DPU 40 makes initial processing of image data passing from cameras and audio data from microphones and transfers the data to the smartphone's internal memory for storage and further processing. DPU 40 can handle data from cameras and microphones in various ways, such as, passing raw or semi-processed data to storage, merely storing said data and transferring them to a further processing device, stitching various videos/images and sending the stitched product to VR playing back devices (e.g. VR headsets), and so forth.

DPU 40 can be a part of smartphone's chipset. Nevertheless, the chipset for a smartphone might not be powerful enough for processing videos/images or audios from various cameras/microphones; in this case, the DPU 40 may also be a separate chip installed in the smartphone. Also, the DPU 40 may be purely software solution.

In a still further embodiment, in order to compensate smartphone orientation changes during record of VR content, a gyroscope 20 and/or magnetic compass 30 is included, and during record of VR content, the data from gyroscope 20 and/or magnetic compass 30 should be recorded. This allows to set VR content orientation same as the real scene and compensate smartphone angle offset during record or playback. In order to fix scene orientation while recording VR content, the data of a gyroscope 20 and/or compass 30 should be recorded simultaneously. This allows to adjust VR content orientation during further processing or playback and make it similar to the real scene orientation, regardless of the smartphone orientation at the scene.

FIG. 3 illustrates functional block diagram of VR content production technical solution. As illustrated, video/image data captured by various cameras, audios data captured by various microphones and data of the gyroscope 20/magnetic compass 30(if present) may be transferred to the DPU 40. In said DPU 40, various data could be processed, such as be stitched. Alternatively, data, including the data from gyroscope 20/magnetic compass 30, could be transferred to the CPU (Center Processing Unit) or other functional hardware of the smartphone for further processing.

By the smartphone with the VR content production assembly, VR content can be comfortably produced by recording full scene in all directions. The user can hold the smartphone in a usual way by left and right sides in the lower part of thereof. Further, with a gyroscope 20, the produced VR content is completed by orientation data, which allows to adjust VR content orientation to the real scene orientation during playback or processing. The produced VR content can be viewed and/or processed on VR devices and software solutions correctly, and the produced VR content would be at high quality level.

1. A smartphone with a VR content capturing assembly, wherein said VR content capturing assembly comprises:
at least two cameras, which cooperatively cover a total angle of view of at least 360° in at least one of the length dimension, height dimension and width dimension of the smartphone.

2. The smartphone as claimed in claim 1, in the dimension in which the coverage of a total angle of view of at least 360° is obtained, the angles of view of any two adjacent cameras overlap with each other.

3. The smartphone as claimed in claim 1, wherein said at least two cameras are six cameras each of which is located on one face of the smartphone.

4. The smartphone as claimed in claim 3, wherein said smartphone comprises 3 pairs of side faces, the faces of each pair parallel to and opposite to each other, the two cameras on respective ones of each pair are located at the same positions of respective faces.

5. The smartphone as claimed in claim 4, wherein the cameras on the front, back, left and right sides of the smart phone are all located at the upper parts of respective smartphone faces.

6. The smartphone as claimed in claim 1 or claim 2, wherein said at least two cameras are 2, 3, 4 or 5 cameras.

7. The smartphone as claimed in claim 1 or claim 2, wherein at least one of the smartphone faces is provided with more than one camera, or is not provided with any camera.

8. The smartphone as claimed in claim 1 or claim 2, wherein said VR content capturing assembly further comprises microphones the quantity of which is identical with that of the cameras and each of which is paired with one corresponding camera, for capturing audio signals associated with the angle of view of a respective paired camera.

9. The smartphone as claimed in claim 3, wherein said VR content capturing assembly further comprises microphones the quantity of which is identical with that of the cameras and each of which is paired with one corresponding camera, for capturing audio signals associated with the angle of view of a respective paired camera.

10. The smartphone as claimed in claim 1, wherein said VR content capturing assembly further comprises a gyroscope or magnetic compass for compensating smartphone orientation changes during capture of VR content.

11. The smartphone as claimed in claim 1, wherein said VR content capturing assembly further comprises a data processing unit, which is integrated with or separate from the smartphone.

12. A portable electronic telecommunication device with a VR content capturing assembly, wherein said VR content capturing assembly comprises:
at least two cameras, which cooperatively cover a total angle of view of at least 360° in at least one of the length dimension, height dimension and width dimension of the portable device.
